(19) United States
(12) Patent Application Publication
(10) Pub. No.: US 2007/0247716 A1
(43) Pub. Date: Oct. 25, 2007

(54) FABRICATING METHOD FOR OPTICAL MULTILAYER THIN FILM STRUCTURE

(75) Inventors: Myoung Jin KIM, Gyeonggi-do (KR); Hwe Kyung KIM, Seoul (KR)

Correspondence Address: RODMAN RODMAN, 10 STEWART PLACE, SUITE 2CE, WHITE PLAINS, NY, 10603, US

(73) Assignee: KOREA ELECTRONICS TECHNOLOGY INSTITUTE, Gyeonggi-do (KR)

(21) Appl. No.: 11/737,969

(22) Filed: Apr. 20, 2007

(30) Foreign Application Priority Data
Apr. 25, 2006 (KR) 10-2006-0037000

(51) Int. Cl. G02B 1/10

(52) U.S. Cl. 359/586

(57) ABSTRACT

A fabricating method for optical multilayer thin film structure is disclosed wherein a QWOT stacked film structure is formed on a substrate from which a deposition rate is analyzed, and a non-QWOT stacked film structure is formed using the analyzed deposition rate, and the analyzed deposition rate is applied to the non-QWOT stacked film structure, and wherein thin film thickness control layers having a QWOT are periodically formed on an optical multilayer thin film structure and a deposition rate thereof is applied to a non-QWOT stacked film structure fabricated thereafter, such that thickness of a non-QWOT stacked film structure can be accurately controlled and a multilayer bandpass filter having a pass band desired by an optical device can be embodied.

### CROSS-REFERENCE TO RELATED APPLICATION

The present application is based on, and claims priority from, Korean Application Number 10-2006-0037000, filed Apr. 25, 2006, the disclosure of which is incorporated by reference herein in its entirety.

### BACKGROUND

Aspects of the following description are directed to a fabricating method for optical multilayer thin film structure. Due to recent growing demand for thin films having features of anti-reflection, high reflection, polarization splitting characteristics or bandpass, technical expertise has been greatly required for precisely controlling optical properties of multilayer thin films with regard to structural control of the thin films.

Dielectric materials having low extinction coefficients in visible light region and near infrared region such as SiO₂, MgF₂, ZrO₂, TiO₂, Ge and Ta₂O₅ as functional thin films are employed for various optical devices and optical elements.

As in known in the process, multilayer systems consisting of several stacked layers of dielectric materials with various refractive indexes are used, in which dielectric thin film layers having a high refractive index material such as ZrO₂, TiO₂, Ge and Ta₂O₅ and dielectric thin film layers having a relatively low refractive index such as SiO₂, MgF₂ are usually stacked alternately on top of each other.

At this time, albedo (or transmittance), bandpass width, transmission wavelength region and the like are determined by difference of refractive indexes, the number of stacking and stacked structures of alternately stacked thin films.

If there exists a dielectric material having an adequate refractive index in embodying a light characteristic required in the optical system, designing of optical thin film structure would be easy. However, If there is no dielectric material having an adequate refractive index in implementing a light characteristic required in the optical system, it is imperative that the required light characteristic be implemented through a thin film optical designing with thickness of the thin film and structure as variables using existing dielectric materials.

In designing the optical thin film, the optical thickness of a layer is typically expressed in terms of a Quarter Wave Optical Thickness (QWOT), where the optical thickness of a dielectric layer is defined to be the refractive index (n) of the material multiplied by the physical thickness (d) of the layer. In other words, a typical measurement of an optical thin film layer is the Quarter Wave Optical Thickness (QWOT) of the layer. The QWOT is defined as the wavelength at which the optical thickness of the layer is equal to one quarter of the wavelength and is defined generally by the formula of QWOT=4 nd.

The QWOT also defines a particular thin film thickness that gives rise to destructive interference and constructive interference relative to used wavelength. FIG. 1 is a cross-sectional view of a multilayer thin film structure based on QWOT.

As illustrated in FIG. 1, a substrate 10 is alternately stacked thereon with a layer 20 having a high refractive index and a layer 30 having a low refractive index. The layer 20 having a high refractive index and the layer 30 having a low refractive index are deposited on top of each other, each having a QWOT.

Most of the optical multilayer thin films are designed by alternately depositing thin films having dielectric materials each of different refractive index based on the QWOT, such that thickness control relative to the QWOT of the deposited materials is very important in determining characteristics of the optical multilayer thin films.

Controlling methods for optical thin film thickness may be largely categorized into three types, that is, (1) a thickness control method using deposition rate dependent on time (2) a thickness control method using a quartz crystal oscillator, and (3) a real time optical thickness control method using reflection/transmission.

First, the thickness control method using deposition rate dependent on time is performed in such a manner that a substrate is thickly evaporated with dielectric materials, and a vapor deposition rate is computed dependent on time which is applied in an actual process. This method suffers from a problem of changing the deposition rate dependent on the time in response to process variables such as temperature, the number of rotation, supplied voltage, supplied current and infused gas quantity.

If the deposition rate is changed dependent on time in response to the process variables, errors relative to the thin film thickness control increase, resulting in a considerable inaccuracy in the layer thickness, whereby the optical characteristics, such as reflectivity, transmittance, transmission wave region and transmission wave bandwidth, decrease.

As a result, it has been shown to be disadvantageous to employ the thickness control method using deposition rate dependent on time as it may be applied to an optical multilayer thin film structure of 40 layers or fewer having a relatively large process error allowance, but may be difficult in applying to an optical multilayer thin film structure consisting of hundreds of layers.

Second, the thickness control method using a quartz crystal oscillator is the most widely used thickness control method. In this method, when electrodes are mounted on both sides of a quartz crystal and an appropriate alternating current (AC) is applied across the electrodes, the quartz crystal oscillates at one of its intrinsic resonant frequencies according to characteristics of the quartz crystal, which is caused by the piezoelectric phenomenon. The intrinsic resonant frequency of the quartz crystal varies to a crystal plate and thickness of the electrodes, and these factors are determined in the manufacture of the quartz crystal.

At this time, the actual resonant frequency may deviate from its intrinsic resonant frequency when the electrode surface on the intrinsic resonant frequency-determined quartz crystal experiences absorption, desorption, chemical and physical changes. As a result, the oscillating frequency of the quartz crystal is changed to the deposited thin film thickness when the electrode surface of the quartz crystal is deposited with thin films. At this time, the thin film thickness is measured and controlled by converting the oscillating frequency to thin film thickness.

However, there is a limitation in manufacturing a multilayer thin film having a thickness of two-digit μm due to limited detection of the oscillating frequency, as resolutions of the oscillating frequency of the quartz crystal gradually decrease in response to thickening of the deposited thin films.

Third, the real time optical thickness control method using reflection/transmission is a method in which transmittance change is detected to control the thin film thickness when light emitted from a monochromator passes through a multilayer thin film to penetrate a substrate.

In a case of an optical multilayer thin film based on the QWOT, the transmittance decreases as the thin film thickness increases, and an inflection point (singular point) appears where the decreasing transmittance increases around the QWOT.

The inflection point repeatedly appears at a thin film thickness corresponding to integer times of the QWOT, and the inflection point is a value where a differential value mathematically becomes ‘0’ at a transmittance curve. Therefore, it should be noted that a thin film thickness of the QWOT can be controlled if a point is read where the differential value becomes “0” at the transmittance curve.

FIG. 2 is a graph illustrating a transmittance change in response to an increase of a thin film thickness in an optical multilayer thin film structure based on the QWOT.

Referring to FIG. 2, it can be noted that the transmittance decreases as thickness of a thin film deposited on a substrate increases, and an inflection point appears where the transmittance increases around the QWOT. The inflection point repeatedly appears at a thin film thickness corresponding to integer times of the QWOT, and a low transmittance at the inflection point appears as the thin film thickness thickens.

Concomitant with recent commercialization of an optical multilayer thin film structure comprising more than 200 layers in an optical communication field as a transmission band filter relative to a specific wave, the optical thickness control method using reflection/transmission in real time is typically employed in accordance with development of thin film designing and process techniques thereof.

In case of an optical thin film based on the QWOT basic structure, an excellent result can be shown on the thin film control by the optical thickness control method using reflection/transmission in real time relative to the thin film thickness.

However, the optical thin film structure based on the QWOT becomes discontinued in terms of changes of the transmission band, and particularly, in case of using the thin film structure on a multilayer transmission band filter, intervals of the transmission bands are discontinued, and it is difficult to change the transmission bandwidth, such that it is next to impossible to fabricate an optical thin film for multilayer transmission band having a particular transmission wavelength band.

In other words, the optical thin film structure based on the QWOT changes the thin film thickness to a thickness corresponding to integer times (an integral number of times) the QWOT, such that the optical characteristic changes resultant therefrom, for example, intervals of the transmission band or changes of transmission bandwidth, appear discontinuously, whereby there occurs a difficulty in manufacturing an optical filter having a particular transmission wavelength band.

As one way of overcoming this problem, a dielectric material having a refractive index capable of embodying the particular transmission wavelength band is employed, or an optical thin film thickness is adjusted, where, the former has a difficulty due to limitation of the dielectric materials. As a result, a prerequisite is that the optical characteristic must be satisfied by forming an entire region or part of the optical multilayer thin film with a non-QWOT thin film structure.

FIG. 3 illustrates a comparison of multilayer transmission band optical filter between an optical thin film structure based on the QWOT and an optical thin film structure based on non-QWOT, where the transmission wavelength bands of the multilayer transmission band optical filter are given as 1,290 nm˜1,350 nm, and 1,550 nm±6.5 nm.

FIG. 3A is a graph illustrating a characteristic of a multilayer transmission band optical filter in the optical thin film structure based on the QWOT.

Referring to FIG. 3A, transmittance decrease in a wavelength region of 1,300˜1,350 nm and discontinuity of transmission wavelength bands can be noted.

FIG. 3B is a graph illustrating a characteristic of a multilayer transmission band optical filter in the optical thin film structure based on the non-QWOT.

It could also be noted that a high transmittance appears at wavelength bands of 1,290 nm˜1,350 nm and 1,550 nm±6.5 nm, which are transmission wavelength bands targeted for the multilayer transmission band optical filter.

As noted above, formation of an entire region or part of the optical multilayer thin film with a non-QWOT thin film structure could help manufacture multiple transmission wavelength band filters such as, for example, optical cubes for laser scanning confocal microscopes, multiple wavelength optical filters and laser-applied optical filters.

However, it is very difficult to control the thin film thickness by way of the real time optical thickness control method using reflection/transmission in case of the thin film based on non-QWOT. In other words, there is a problem in thin film thickness control for the thin film based on the non-QWOT due to absence of inflection point caused by changes of transmittance.

### SUMMARY

Accordingly, an object is to provide a fabricating method for high precision optical multilayer thin film whereby a QWOT stacked film structure is formed on a substrate that is capable of easily controlling thin film thickness to analyze deposition rate, the analyzed deposition rate is applied to a non-QWOT stacked film structure, and deposition rate of a periodically-formed thin film thickness control layer comprising QWOT thickness is utilized for application to a non-QWOT stacked film structure formed thereafter.

In a general aspect, a fabricating method for optical multilayer thin film comprises: forming a Quarter Wave Optical Thickness (QWOT) stacked film structure on a substrate in which a material layer having a first refractive index and a material layer having a second refractive index different from the first refractive index are stacked alternately on top of each other; and forming a non-QWOT stacked film structure on the QWOT stacked film structure in which a material layer having a first refractive index and a material layer having a second refractive index are stacked alternately on top of each other.

Implementations of this aspect may include one or more of the following features.

The first refractive index is higher than the second refractive index.

The material layer having the first refractive index includes a material selected from a group comprising ZrO₂, TiO₂, Ge and Ta₂O₅.

The material layer having the second refractive index includes SiO₂ or MgF₂.

Subsequent to the step of forming the non-QWOT stacked film structure, the method further comprises: repeatedly performing the step of forming on the non-QWOT stacked film structure a thin film thickness control layer having a thickness of integer times the QWOT and the step of forming the non-QWOT stacked film structure on the thin film thickness control layer at least two times.

The thin film thickness control layer comprises: a first thin film thickness control layer composed of a first refractive index; and a second thin film thickness control layer formed on the first thin film thickness control layer and composed of material having a second refractive index different from the first refractive index.

The method further comprises forming a non-QWOT stacked film structure between the first thin film thickness control layer and the second thin film thickness control layer.

The step of forming the non-QWOT stacked film structure on the thin film thickness control layer comprises: analyzing deposition rates of the first thin film thickness control layer and the second thin film thickness control layer; forming on the thin film thickness control layer a first non-QWOT film structure having a same refractive index as that of the first thin film thickness control layer using the deposition rate of the first thin film thickness control layer; forming on the first non-QWOT film structure a second non-QWOT film structure having a same refractive index as that of the second thin film thickness control layer using the deposition rate of the second thin film thickness control layer; and forming a non-QWOT stacked film structure by repeatedly performing the step of forming the first non-QWOT film structure and the step of forming the second non-QWOT film structure.

### BRIEF DESCRIPTION OF THE DRAWINGS

FIG. 1 is a cross-sectional view of a multilayer thin film structure based on QWOT.

FIG. 2 is a graph illustrating a transmittance change in response to an increase of a thin film thickness in an optical multilayer thin film structure based on the QWOT.

FIG. 3A is a graph illustrating a characteristic of a multilayer transmission band optical filter in the optical thin film structure based on the QWOT.

FIG. 3B is a graph illustrating a characteristic of a multilayer transmission band optical filter in the optical thin film structure based on the non-QWOT.

FIG. 4 is a flowchart illustrating an implementation of a fabricating method for an optical multilayer thin film structure.

FIG. 5 is a cross-sectional view illustrating an example of an optical multilayer thin film structure.

FIG. 6 is a cross-sectional view illustrating another example of an optical multilayer thin film structure.

FIGS. 7A to 7E are cross-sectional views illustrating examples of fabricating methods for optical multilayer thin film structure.

FIGS. 8A to 8E are cross-sectional views illustrating different examples of fabricating methods for optical multilayer thin film structure.

FIG. 9 is a graph illustrating transmittance changes in an optical multilayer thin film structure.

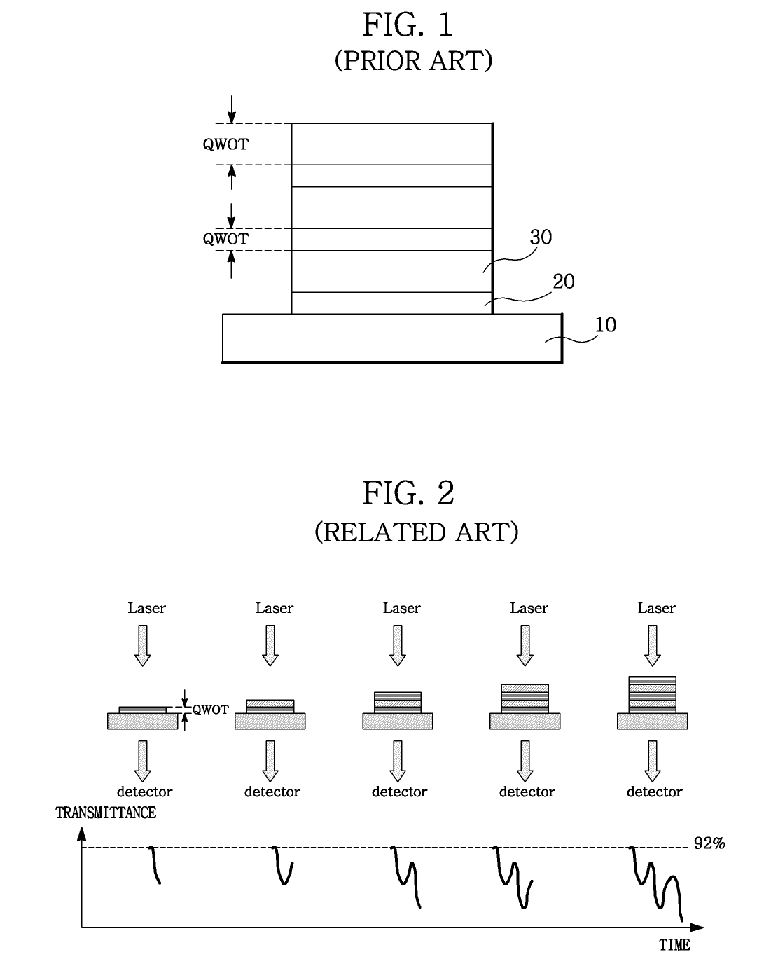

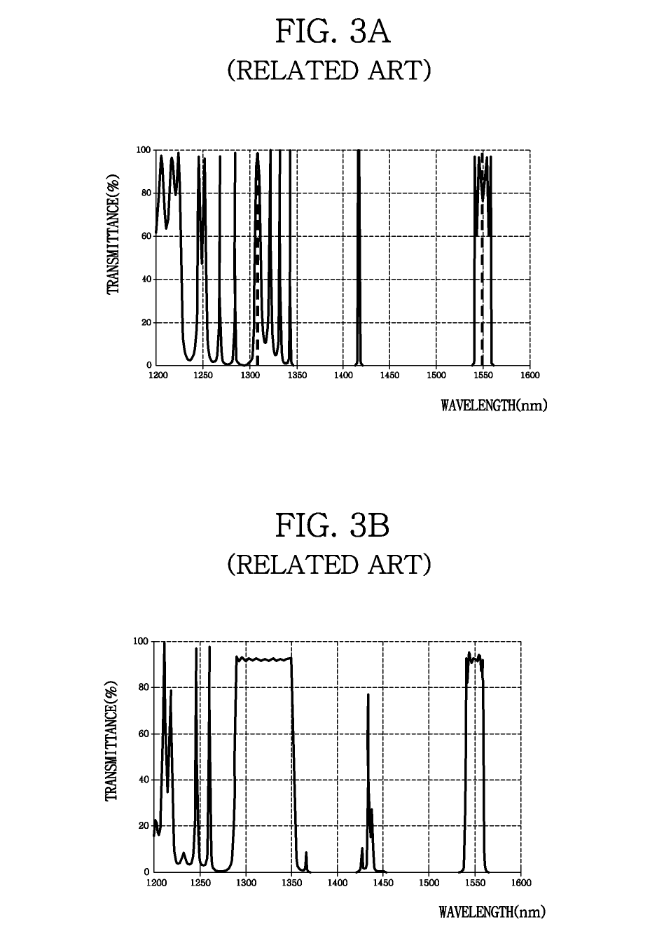

### DETAILED DESCRIPTION

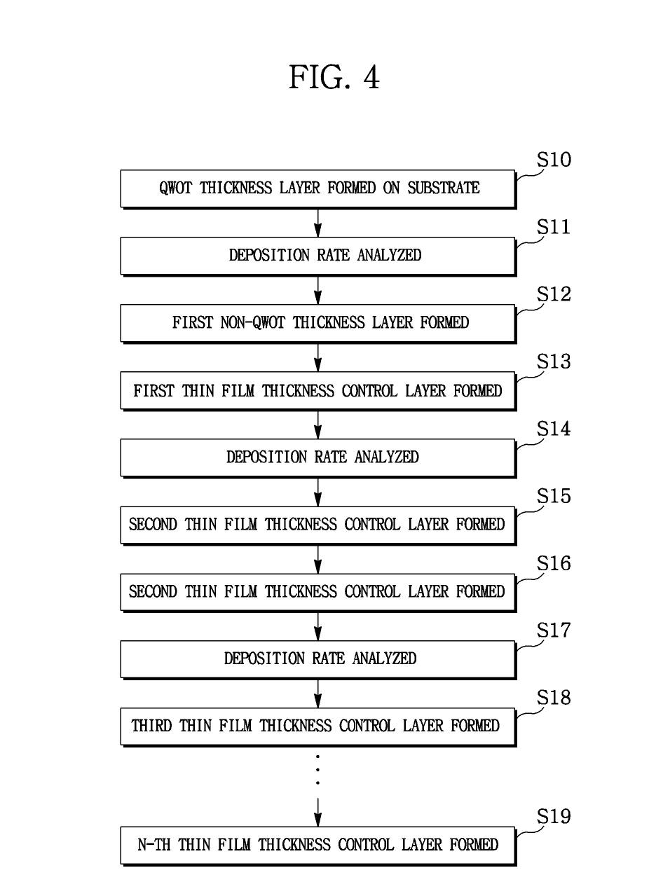

Referring to FIG. 4 which is a flowchart illustrating an implementation of a fabricating method for an optical multilayer thin film structure, a QWOT stacked film structure is first formed on a substrate (S10).

The QWOT stacked film structure is formed by alternately stacking a dielectric material layer of a high refractive index and a dielectric material layer of a low refractive index on top of each other, and the dielectric material layer of higher refractive index and the dielectric material layer of low refractive index are respectively deposited with QWOT thickness.

The number of alternately stacking the dielectric material layer of high refractive index and the dielectric material layer of low refractive index conform to the number of stacking designed for embodying an optical characteristic required by optical devices.

The thickness of each layer comprising the QWOT stacked film structure may be controlled by the real time optical thickness control method using reflection/transmission.

As apparent from the foregoing, e.g., in a case of an optical multilayer thin film based on the QWOT, the transmittance decreases as the thin film thickness increases, and an inflection point (singular point) appears where the decreasing transmittance increases around the QWOT.

The inflection point corresponds to a value where a differential value mathematically becomes ‘0’ at a transmittance curve. Therefore, it should be noted that a thin film thickness of the QWOT can be controlled if a point is read where the differential value becomes “0” at the transmittance curve.

Successively, the deposition rate of the QWOT stacked film structure is analyzed (S11). In other words, respective deposition rates of the dielectric material layer of the high refractive index and the dielectric material layer of the low refractive index are analyzed in the QWOT stacked film structure, where the deposition rates are computed using the number of stacking and deposited times of the dielectric material layer of the high refractive index and the dielectric material layer of the low refractive index.

Then, a first non-QWOT stacked film structure is formed on the QWOT stacked film structure using the analyzed deposition rates (S12). In other words, the first non-QWOT stacked film structure is formed on an upper surface of the QWOT stacked film structure using the analyzed deposition rates of the dielectric material layer of the high refractive index and the dielectric material layer of the low refractive index. The first non-QWOT stacked film structure is formed by alternately stacking the dielectric material layer of the high refractive index and the dielectric material layer of the low refractive index, where the dielectric material layer of the high refractive index and the dielectric material layer of the low refractive index are respectively formed with a predetermined thickness of the non-QWOT thickness.

The number of alternate stacks of the dielectric material layer of high refractive index and the dielectric material layer of low refractive index is determined by deposited state and performance of a depositor.

Successively, a first thin film thickness control layer is formed on the first non-QWOT stacked film structure (S13). The first thin film thickness control layer is formed by a dielectric material layer having a high refractive index or a dielectric material layer having a low refractive index, and has a thickness at least twice the QWOT and integer times the QWOT.

Now, a deposition rate of the first thin film thickness control layer is analyzed (S14).

The first thin film thickness control layer is formed with a thickness corresponding to integer times of the QWOT, which results in appearance of the inflection point, so the thin film thickness can be controlled thereby.

Furthermore, because the first thin film thickness control layer is formed with a thickness twice the QWOT or more, two or more inflection points appear, by which a deposition rate of the first thin film thickness control layer can be analyzed.

In other words, the thickness of the first thin film thickness control layer can be known by a point where the inflection point appears at a transmittance curve, i.e., where a differential value becomes “0” at the transmittance curve, and a deposition rate of the first thin film thickness control layer can be computed by a deposition time between two inflection points.

The reason of forming the first thin film thickness control layer and analyzing the deposition rate again is to prevent the optical thin film from deviating from an error allowance rate when the time of alternately stacking the dielectric material layer of the high refractive index and the dielectric material layer of the low refractive index in the first non-QWOT stacked film structure increases.

In other words, the reason is that, although the first non-QWOT stacked film structure is formed using the deposition rate of the QWOT stacked film structure, the possibility of generating errors increases as the number of alternate stacking increases in the first non-QWOT stacked film structure, such that the stacking is to be made only within the error allowance rate of the optical films, and thereafter, a second non-QWOT stacked film structure is to be formed using the deposition rate analyzed through the first thin film thickness control layer.

Successively, the first thin film thickness control layer is formed thereon with a second non-QWOT stacked film structure (S15).

The second non-QWOT stacked film structure is formed by alternately stacking a dielectric material layer having a high refractive index or a dielectric material layer having a low refractive index, on top of each other, as in the first non-QWOT stacked film structure, but is formed with a thickness as thick as a pre-designed thickness using the deposition rate analyzed when the first thin film thickness control layer is formed.

Then, the second non-QWOT stacked film structure is formed thereon with a second thin film thickness control layer (S16). Although the second thin film thickness control layer is formed with a dielectric material layer of a high refractive index or a dielectric material layer of a lower refractive index, the second thin film thickness control layer is formed with a dielectric material layer having a refractive index different from that of the first thin film thickness control layer.

In other words, if the first thin film thickness control layer is formed with a dielectric material having a high refractive index, the second thin film thickness control layer is formed with a dielectric material having a low refractive index, and if the first thin film thickness control layer is formed with a dielectric material having a low refractive index, the second thin film thickness control layer is formed with a dielectric material having a high refractive index.

Furthermore, the second thin film thickness control layer is formed with a thickness corresponding to integer times of the QWOT, e.g, with a thickness at least twice the QWOT or more.

Successively, a deposition rate of the second thin film thickness control layer is analyzed (S17), and a third non-QWOT stacked film structure is formed on the second thin film thickness control layer using the analyzed deposition rate (S18).

Thereafter, a thin film thickness control layer is formed to analyze a deposition rate, and formation of non-QWOT stacked film structures is repeatedly implemented until forming an nth non-QWOT stacked film structure, using the analyzed deposition rate (S19).

According to the present implementation as noted above, optical thin films (i.e., a QWOT stacked film structure and thin film thickness control layer) based on the QWOT capable of implementing an excellent thickness control is formed by the real time optical thickness control method using reflection/transmission, a deposition rate is analyzed and non-QWOT stacked film structures are formed using the analyzed deposition rate to fabricate high precision non-QWOT optical multilayer thin films.

In other words, when thin film thickness control layers are formed between the non-QWOT stacked film structure, the thin film thickness control layers are periodically formed between the non-QWOT stacked film structures, where a thickness control layer relative to a dielectric material having a high refractive index and a thickness control layer having a dielectric material having a low refractive index are alternately formed, such that deposition rates relative to the dielectric material having a high refractive index and the dielectric material having a low refractive index can be respectively analyzed.

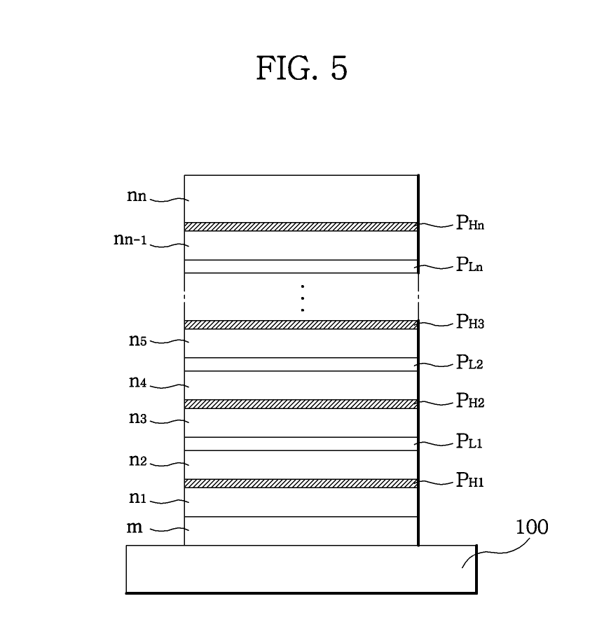

FIG. 5 is a cross-sectional view illustrating an example of an optical multilayer thin film structure.

Referring to FIG. 5, a QWOT stacked film structure (m) is formed on a substrate (100), a non-QWOT stacked film structure (n₁) is formed on the QWOT stacked film structure (m), a high refractive index control layer (P_{H1}) is formed on the non-QWOT stacked film structure (n₁), a non-QWOT stacked film structure (n₂) is formed on the high refractive index control layer (P_{H1}), a low refractive index control layer (P_{L1}) is formed on the non-QWOT stacked film structure (n₂), the low refractive index control layer (P_{L1}) is repeatedly stacked thereon with a non-QWOT stacked film structure, a high refractive index control layer, a non-QWOT stacked film structure and a low refractive index control layer, and a non-QWOT stacked film structure (n_{N}) is formed on an uppermost layer.

The QWOT stacked film structure (m) is formed by alternately stacking a dielectric material layer having a high refractive index and a dielectric material layer having a low refractive index, where the dielectric material having a high refractive index and the dielectric material having a low refractive index are respectively formed with a QWOT.

The dielectric material having a high refractive index may consist of one of the materials selected from a group of ZrO₂, TiO₂, Ge and Ta₂O₅ and the dielectric material having a low refractive index may consist of SiO₂ or MgF₂.

The number of alternate stacking where the dielectric material having a high refractive index and the dielectric material having a low refractive index are alternately stacked conforms to a designed number for embodying the optical characteristic required by an optical device.

The non-QWOT stacked film structures (n₁˜n₂) are alternately stacked with a dielectric material layer having a high refractive index and a dielectric material layer having a low refractive index, where the dielectric material layer having a high refractive index and the dielectric material having layer a low refractive index are respectively formed with a QWOT, which is a thickness predetermined for embodying the optical characteristic.

The high refractive index control layers (P_{H1}˜P_{Hn}) are intended to provide a standard for deposition rates of the high refractive index material layers of subsequently formed non-QWOT stacked film structures, which are thickness control layers to be used for controlling thin film thicknesses of the subsequently formed non-QWOT stacked film structures.

The high refractive index control layers (P_{H1}˜P_{Hn}) may be made of one of the materials selected from a group of ZrO₂, TiO₂, Ge and Ta₂O₅, each thickness being integer times of QWOT, preferably at least twice the QWOT.

The low refractive index control layers (P_{L1}˜P_{Ln}) are intended to provide a standard for deposition rates of the low refractive index material layers of subsequently formed non-QWOT stacked film structures, which are thickness control layers to be used for controlling thin film thicknesses of the subsequently formed non-QWOT stacked film structures.

The low refractive index control layers (P_{L1}˜P_{Ln}) may be made of SiO₂ or MgF₂, the thickness thereof being integer times of the QWOT, preferably at least twice the QWOT.

The high refractive index control layers (P_{H1}˜P_{Hn}) and the low refractive index control layers (P_{L1}˜P_{Ln}) are formed in a predetermined period, a periodic interval thereof being determined by deposition state of the non-QWOT stacked film structures (n₁˜n₂) and performance of a depositor.

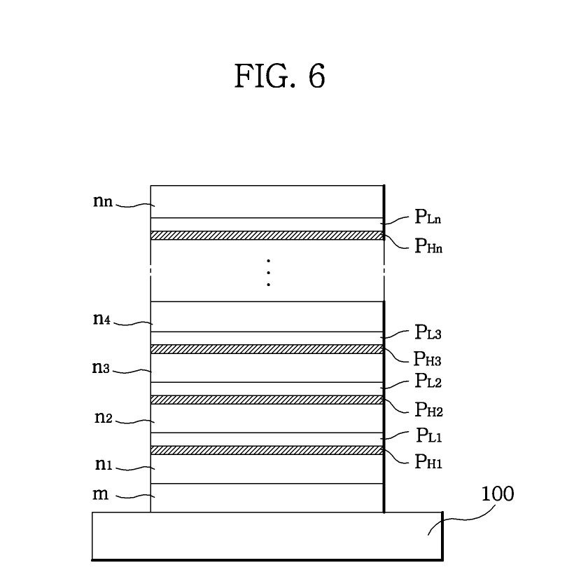

Now, referring to FIG. 6, the non-QWOT stacked film structures (n₁˜nₙ₋₁) may be sequentially stacked thereon with the high refractive index control layers (P_{H1}˜P_{Hn}) and the low refractive index control layers (P_{L1}˜P_{Ln}) as thickness control layers.

If the thickness control layers are formed as above, the non-QWOT stacked film structures formed on the thickness control layers can be controlled of thickness thereof using each deposition rate of the high refractive index control layers (P_{H1}˜P_{Hn}) and the low refractive index control layers (P_{L1}˜P_{Ln}).

According to the present implementation, the deposition rate can be analyzed by the QWOT stacked film structures (including the thickness control layers), and thickness of the non-QWOT stacked film structure can be controlled by the analyzed deposition rates to thereby enable to realize the high precision non-QWOT optical thin film structure.

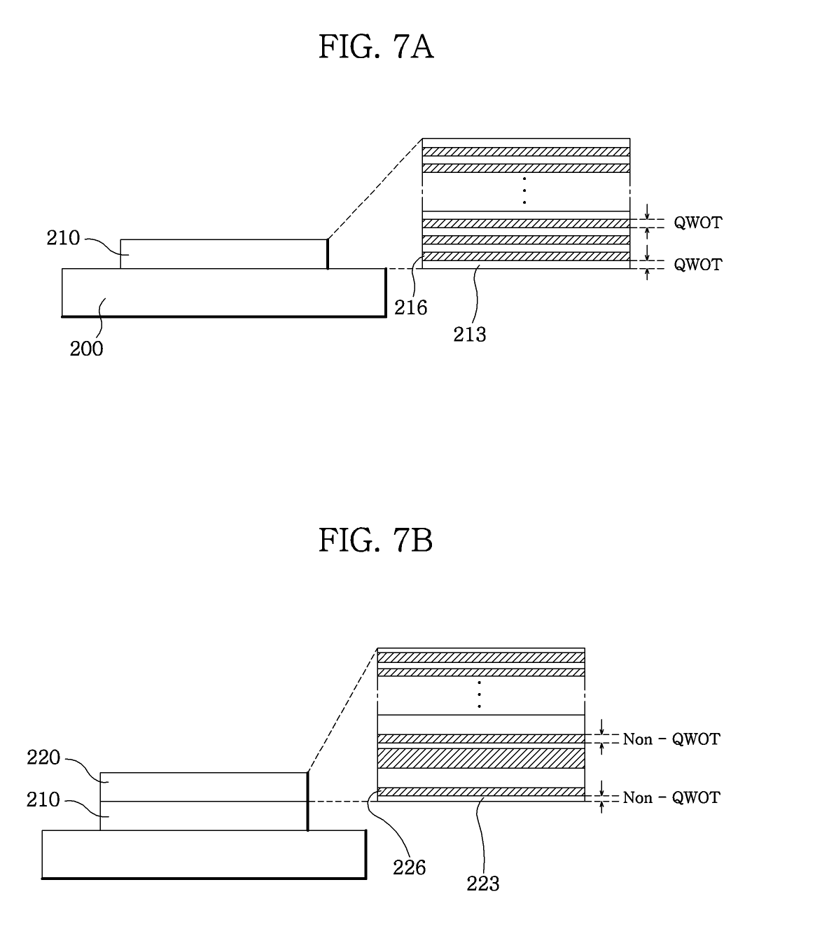

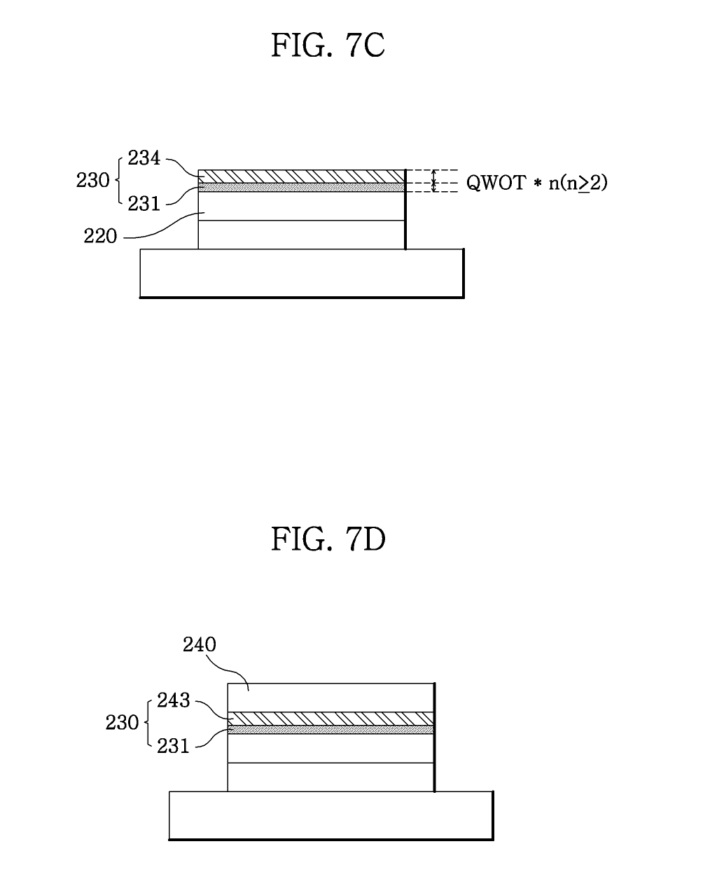

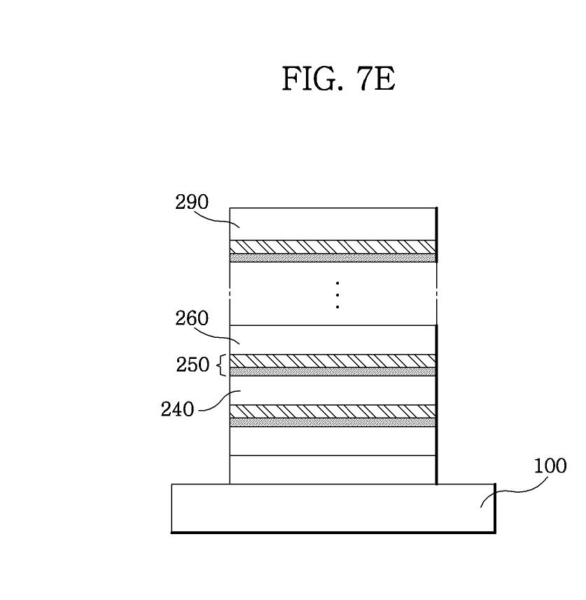

FIGS. 7A to 7E are cross-sectional views illustrating examples of fabricating methods for optical multilayer thin film structure.

Referring to FIG. 7A, a substrate (200) is formed thereon with a QWOT stacked film structure (210). The QWOT stacked film structure (210) is formed by alternately stacking a dielectric material layer (213) having a high refractive index and a dielectric material layer (216) having a low refractive index, where the dielectric material layer (213) having a high refractive index and the dielectric material layer (216) having a low refractive index are respectively formed with a QWOT.

The dielectric material (213) having a high refractive index consists of one of the materials selected from a group of ZrO₂, TiO₂, Ge and Ta₂O₅ and the dielectric material (216) having a low refractive index consists of SiO₂ or MgF₂.

Next, the QWOT stacked film structure (210) is formed thereon with a first non-QWOT stacked film structure (220) (FIG. 7B).

The first QWOT stacked film structure (220) is formed by alternately stacking a dielectric material layer (223) having a high refractive index and a dielectric material layer (226) having a low refractive index, where the dielectric material layer (223) having a high refractive index and the dielectric material (226) having layer a low refractive index are respectively formed with a pre-designed non-QWOT.

The dielectric material layer (223) having a high refractive index and the dielectric material layer (226) having a low refractive index in the first QWOT stacked film structure (220) are deposited with deposition rates of the dielectric material layer (213) having a high refractive index and a dielectric material layer (216) having a low refractive index in the QWOT stacked film structure (210).

In other words, deposition rates of the dielectric material layer (213) having a high refractive index and the dielectric material layer (216) having a low refractive index in the QWOT stacked film structure (210) are analyzed, and the dielectric material layer (223) having a high refractive index and the dielectric material layer (226) having a low refractive index in the first non-QWOT stacked film structure (220) are deposited with a pre-designed thickness using the analyzed deposition rates.

Meanwhile, the number of alternate stacking where the dielectric material layer (223) having a high refractive index and the dielectric material layer (226) having a low refractive index are alternately stacked is determined by deposition state and performance of the depositor. In other words, the number of alternate stacking is adjusted in consideration of the deposition state and the performance of the depositor within an error allowance of the optical thin film.

Successively, the first non-QWOT stacked film structure (220) is formed thereon with a first thin film thickness control layer (230) (FIG. 7C).

The first thin film thickness control layer (230) is formed by sequentially stacking a high refractive index control layer (231) and a low refractive index control layer (234).

The high refractive index control layer (231) and the low refractive index control layer (234) are formed with a thickness corresponding to integer times the QWOT, e.g, with a thickness at least twice the QWOT or more.

The reason of forming the first thin film thickness control layer (230) is to prevent the optical thin films from deviating from an error allowance rate because the number of alternate stacking is adjusted to allow the non-QWOT stacked film structure (220) to be stacked within an error allowance rate of the optical thin films, and if the stacking of the thin films exceeds the error allowance rate, there is a high likelihood of failing to show the wanted optical characteristics, for example, transmittance band and the like. The reason is therefore to re-rectify the deposition rate through the first thin film thickness control layer (230) for application to subsequently stacked thin films.

The first thin film thickness control layer (230) is formed in the QWOT thin film structure, which enables an excellent thickness control according to the real time optical thickness control method using reflection/transmission, and also facilitates an easy analysis of the deposition rate if used with the inflection point that occurs in response to the transmittance changes.

Successively, the first thin film thickness control layer (230) is formed thereon with a second non-QWOT stacked film structure (240) (FIG. 7D). The second non-QWOT stacked film structure (240) is formed using the analyzed deposition rates following analyses of deposition rates of the high refractive index control layer (231) and the low refractive index control layer (234) in the first thin film thickness control layer (230).

In other words, a high refractive index dielectric material layer of the second non-QWOT stacked film structure (240) is first formed using the deposition rate of the high refractive index control layer (231), and then a low refractive index dielectric material layer of the second non-QWOT stacked film structure (240) is formed using the deposition rate of the low refractive index control layer (234).

Now, once the second non-QWOT stacked film structure (240) is formed using the deposition rate of the first thin film thickness control layer (230) as a basic deposition rate following the formation of the first thin film thickness control layer (230), the thickness control can be easily effected despite the non-QWOT thin film structure.

Next, the second non-QWOT stacked film structure (240) is formed thereon with a second thin film thickness control layer (250), a third non-QWOT stacked film structure (260) is formed using the deposition rate of the second thin film thickness control layer (250), and thin film thickness control layers and non-QWOT stacked film structures are repeatedly formed in the same manner as above to form up to a nth non-QWOT stacked film structure (290) (FIG. 7E).

The thin film thickness control layers consisting of high refractive index control layers and low refractive index control layers are periodically formed in the present implementation, where a periodic interval of the thin film thickness control layers is decided by performance of a depositor.

To be more specific, as the periodic interval of the thin film thickness control layers is determined by the non-QWOT stacked film structures formed between the thin film control layers, it can be said that the periodic interval of the thin film thickness control layers is decided by performance of the depositor because the non-QWOT stacked film structures are formed within the error allowance rate of the optical thin film in consideration of the depositor.

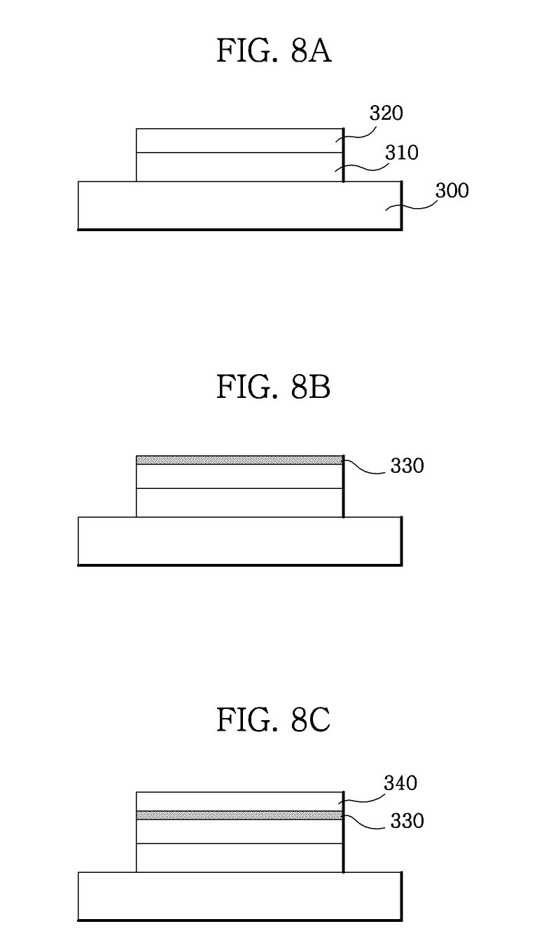

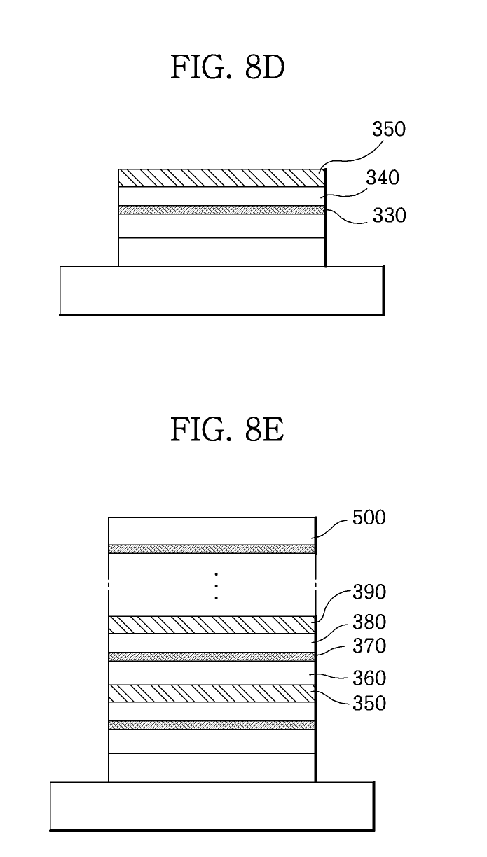

Now, referring to FIGS. 8A to 8E which show cross-sectional views illustrating different examples of fabricating methods for optical multilayer thin film structure, a QWOT stacked film structure (310) is formed on a substrate (300), and a first non-QWOT stacked film structure (320) is formed on the QWOT stacked film structure (310), using a deposition rate of the QWOT stacked film structure (310) (FIG. 8A).

The QWOT stacked film structure (310) may be called a kind of thin film thickness control layer as it is a base of deposition rate in forming the first non-QWOT stacked film structure (320).

Next, the first non-QWOT stacked film structure (320) is formed thereon with a high refractive index control layer and a low refractive index control layer as a first thin film thickness control layer (330) (FIG. 8B).

The first thin film thickness control layer (330) is then formed thereon with a second non-QWOT stacked film structure (340), using a deposition rate of the first thin film thickness control layer (330) (FIG. 8C).

Successively, a second thin film thickness control layer (350) is formed on the second non-QWOT stacked film structure (340) (FIG. 8D). The second thin film thickness control layer (350) is formed with a control layer having a refractive index different from that of the second thin film thickness control layer (350).

In other words, if the first thin film thickness control layer (330) is made of a high refractive index control layer, the second thin film thickness control layer (350) is formed with a low refractive index control layer, and if the first thin film thickness control layer (330) is made of a low refractive index control layer, the second thin film thickness control layer (350) is formed with a high refractive index control layer.

Now, the second thin film thickness control layer (350) is sequentially formed with a third non-QWOT stacked film structure (360), a third thin film thickness control layer (370), a fourth non-QWOT stacked film structure (380) and a fifth thin film thickness control layer (39), and thin film thickness control layers and non-QWOT stacked film structures are repeatedly formed in the same manner as above to form upto a nth non-QWOT stacked film structure (500) (FIG. 8E).

In the present implementation, the thin film thickness control layer is formed in such a manner that a high refractive index control layer and a low refractive index control layer are alternately stacked about a non-QWOT stacked film structure, and the thin film thickness control layers are periodically formed with a predetermined interval.

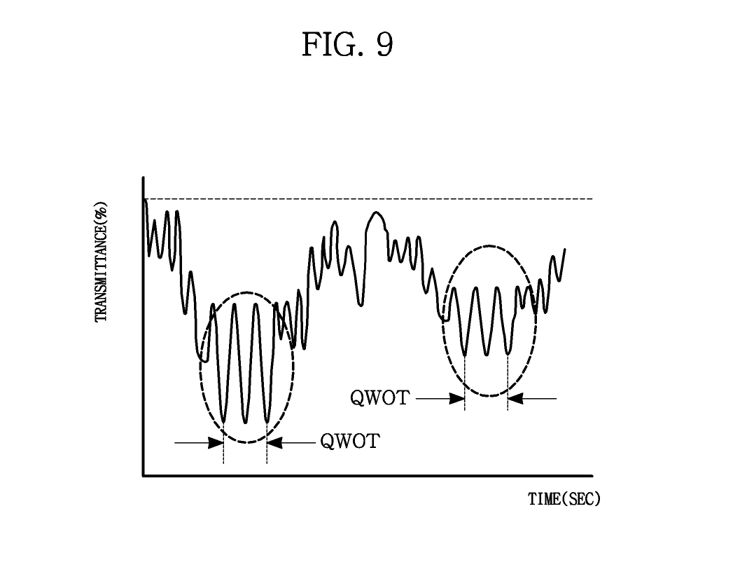

In the present implementation, a deposition rate of thin film thickness control layer having a thickness corresponding to integer times of the QWOT, e.g, with a thickness at least twice the QWOT or more, is analyzed, and a non-QWOT stacked film structure is formed using the analyzed deposition rate, and a principle of analyzing the deposition rate of the thin film thickness control layer will be described with reference to FIG. 9.

FIG. 9 is a graph illustrating transmittance changes in an optical multilayer thin film structure.

The thin film thickness control is formed in integer times of the QWOT, e.g, with a thickness at least twice the QWOT or more, and in case of an optical thin film structure based on the QWOT, the transmittance decreases as the thickness of the thin film increases, but an inflection point where the decreasing transmittance increases appears around the QWOT, and the inflection point repeatedly appears at a thin film thickness corresponding to integer times of the QWOT.

Assuming that there is no extinction coefficient of a thin film, a transmittance at a point where a thickness of the thin film thickness control layer reaches twice the QWOT comes to an original transmittance, decreases again and changes to a shape of a sine curve thereafter.

The thickness of the thin film thickness control layer can be precisely controlled due to (1) formation in the integer times the QWOT and (2) appearance of two or more inflection points caused by formation of a thickness at least twice the QWOT or more, whereby a deposition time of the thin film thickness control layer is known and a deposition rate of the thin film thickness control layer is also analyzed.

Most of the bandpass filters are based on Fabry-Perot structure composed of spacers having thickness of layers even number times the QWOT between high reflection optical thin film layers, which may be applied to the present implementations.

In other words, in case of fabricating a Fabry-Perot structure according to the present implementation, a spacer having a high error sensitivity is given as a thin film thickness control layer from which a deposition rate thereof is analyzed, and the analyzed deposition rate is applied to the non-QWOT stacked film structure, thereby enabling to enhance in real time the accuracy of thickness control relative to thickness-improbable non-QWOT thin film layers.

As apparent from the foregoing, there is an advantage according to the present implementations thus described in that a QWOT stacked film structure is formed on a substrate from which a deposition rate is analyzed, and a non-QWOT stacked film structure is formed using the analyzed deposition rate, enabling to precisely control a thin film thickness of the non-QWOT stacked film structure.

Another advantage is that thin film thickness control layers are periodically formed on an optical multilayer thin film structure and a deposition rate thereof is applied to a non-QWOT stacked film structure fabricated thereafter, such that the deposition rate can be periodically corrected according to performance state of a depositor and the non-QWOT stacked film structure can be formed within an error allowance rate of the optical thin film.

Still another advantage is that, through a QWOT stacked film structure and a thin film thickness control layer, thickness of a non-QWOT stacked film structure can be accurately controlled that is to be stacked following the QWOT stacked film structure and the thin film thickness control layer such that a multilayer bandpass filter having a pass band desired by an optical device can be embodied.

The particular implementations disclosed above are illustrative only, as the implementations may be modified and practiced in different but equivalent manners apparent to those skilled in the art having the benefit of the teachings herein. Furthermore, no limitations are intended to the details of construction or design herein shown, other than as described in the claims below. It is therefore evident that the particular implementations disclosed above may be altered or modified and all such variations are considered within the scope and spirit of the present description. Accordingly, the protection sought herein is as set forth in the claims below.

What is claimed is:

1. A fabricating method for optical multilayer thin film comprises: forming a Quarter Wave Optical Thickness (QWOT) stacked film structure on a substrate in which a material layer having a first refractive index and a material layer having a second refractive index different from the first refractive index are stacked alternately on top of each other; and forming a non-QWOT stacked film structure on the QWOT stacked film structure in which a material layer having a first refractive index and a material layer having a second refractive index are stacked alternately on top of each other.

2. The method as claimed in claim 1, wherein the first refractive index is higher than the second refractive index.

3. The method as claimed in claim 2, wherein the material layer having the first refractive index includes a material selected from a group comprising ZrO₂, TiO₂, Ge and Ta₂O₅.

4. The method as claimed in claim 2, wherein the material layer having the second refractive index includes SiO₂ or MgF₂.

5. The method as claimed in claim 1, wherein the first refractive index is lower than the second refractive index.

6. The method as claimed in claim 5, wherein the material layer having the first refractive index includes SiO₂ or MgF₂.

7. The method as claimed in claim 5, wherein the material layer having the second refractive index includes a material selected from a group comprising ZrO₂, TiO₂, Ge and Ta₂O₅.

8. The method as claimed in claim 1, wherein, subsequent to the step of forming the non-QWOT stacked film structure, the method further comprises: repeatedly performing the step of forming on the non-QWOT stacked film structure a thin film thickness control layer having a thickness of integer times the QWOT and the step of forming the non-QWOT stacked film structure on the thin film thickness control layer at least two times.

9. The method as claimed in claim 9, wherein the thin film thickness control layer has a thickness at least two times or more the QWOT.

10. The method as claimed in claim 8, wherein the thin film thickness control layer includes: a first thin film thickness control layer composed of a first refractive index; and a second thin film thickness control layer formed on the first thin film thickness control layer and composed of a material having a second refractive index which is different from the first refractive index.

11. The method as claimed in claim 10, wherein the first thin film thickness control layer has a higher refractive index than that of the second thin film thickness control layer.

12. The method as claimed in claim 11, wherein the first thin film thickness control layer includes a material selected from a group comprising ZrO₂, TiO₂, Ge and Ta₂O₅.

13. The method as claimed in claim 11, wherein the second thin film thickness control layer includes SiO₂ or MgF₂.

14. The method as claimed in claim 10, wherein the first thin film thickness control layer has a lower refractive index than that of the second thin film thickness control layer.

15. The method as claimed in claim 14, wherein the first thin film thickness control layer includes SiO₂ or MgF₂.

16. The method as claimed in claim 14, wherein the second thin film thickness control layer includes a material selected from a group comprising ZrO₂, TiO₂, Ge and Ta₂O₅.

17. The method as claimed in claim 10 further including forming a non-QWOT stacked film structure between the first thin film thickness control layer and the second thin film thickness control layer.

18. The method as claimed in claim 10, wherein the step of forming the non-QWOT stacked film structure on the thin film thickness control layer includes: analyzing deposition rates of the first thin film thickness control layer and the second thin film thickness control layer; forming on the thin film thickness control layer a first non-QWOT film structure having a same refractive index as that of the first thin film thickness control layer using the deposition rate of the first thin film thickness control layer; forming on the first non-QWOT film structure a second non-QWOT film structure having a same refractive index as that of the second thin film thickness control layer using the deposition rate of the second thin film thickness control layer; and forming a non-QWOT stacked film structure by repeatedly performing the step of forming the first non-QWOT film structure and the step of forming the second non-QWOT film structure.
